(19) United States
(12) Patent Application Publication
(10) Pub. No.: US 2021/0014382 A1
(43) Pub. Date: Jan. 14, 2021

(54) IMAGE FORMING APPARATUS AND IMAGE FORMING METHOD

(71) Applicant: KONICA MINOLTA, INC., Tokyo (JP)

(72) Inventors: Yoshiki Nakazawa, Toyokawa-shi (JP); Takeshi Nomura, Toyohashi-shi (JP); Nobuhiro Matsuo, Toyokawa-shi (JP)

(73) Assignee: KONICA MINOLTA, INC., Tokyo (JP)

(21) Appl. No.: 16/897,375

(22) Filed: Jun. 10, 2020

(30) Foreign Application Priority Data
Jul. 12, 2019 (JP) 2019-130387

(51) Int. Cl. H04N 1/409; H04N 1/00

(52) U.S. Cl. CPC H04N 1/409; H04N 1/00005; H04N 1/00037

(57) ABSTRACT

An image forming apparatus forms an image, and includes: an inputter that inputs image data; an image former that executes image forming processing to form an image on a sheet for each page with the image data inputted by the inputter; a controller that controls the image data processed at the image former; and a noise detector that detects noise, wherein the controller controls to perform, at the image former, image re-forming processing for a page corresponding to image data when the noise detector has detected noise when the image data is being processed.

The entire disclosure of Japanese patent Application No. 2019-130387, filed on Jul. 12, 2019, is incorporated herein by reference in its entirety.

### BACKGROUND

### Technological Field

The present disclosure relates to an image forming apparatus and an image forming method.

### Description of the Related art

In a conventional image forming apparatus such as a printer or a copying machine, there are cases where an image formed on a sheet becomes poor because toner adheres to a fixing unit due to a paper jam, and an image becomes poor due to noise caused by static electricity. A technique has been developed to perform reprinting (recovery processing) without discharging these sheets with poor images to a tray.

In the image forming apparatus described in JP 2018-194580 A, a sheet on which an image has been formed is read by an image reading sensor, a sheet with a poor image is detected based on that result, and reprinting is performed when a sheet with a poor image has been detected. In particular, to print a document composed of a plurality of pages, the image forming apparatus reprints only the sheet with the poor image by utilizing normal sheets printed until the sheet with the poor image is detected. Thus, printing loss is reduced.

However, in the image forming apparatus described in JP 2018-194580 A, the image reading sensor is used to detect image poorness on a sheet on which the image has been formed. Thus, the poorness can be detected only after the image has been formed. Accordingly, in the image forming apparatus, a sheet with a poor image is inevitable, and the printing loss cannot be reduced. Moreover, since the image forming apparatus is forming an image on a subsequent sheet at the time when a sheet with a poor image has been detected, it is inevitably necessary to temporarily withdraw the subsequent sheet and reprint, causing a problem of reducing the productivity.

### SUMMARY

The present disclosure has been conceived in light of the above circumstances, and an object of thereof is to provide an image forming apparatus capable of improving the productivity even when a sheet with a poor image is detected and recovery processing is performed.

To achieve the abovementioned object, according to an aspect of the present invention, there is provided an image forming apparatus that forms an image, and the image forming apparatus reflecting one aspect of the present invention comprises: an inputter that inputs image data; an image former that executes image forming processing to form an image on a sheet for each page with the image data inputted by the inputter; a controller that controls the image data processed at the image former; and a noise detector that detects noise, wherein the controller controls to perform, at the image former, image re-forming processing for a page corresponding to image data when the noise detector has detected noise when the image data is being processed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing the entire configuration of an image forming apparatus;

FIG. 2 is a diagram showing that noise has been detected in a first processing status;

FIG. 3 is a diagram showing image re-forming processing of recovery operation for the first processing status;

FIG. 4 is a diagram showing discard processing of the recovery operation for the first processing status;

FIG. 5 is a diagram showing that noise has been detected in a second processing status;

FIG. 6 is a diagram showing image re-forming processing of recovery operation for the second processing status;

FIG. 7 is a diagram showing discard processing of the recovery operation for the second processing status;

FIG. 8 is a diagram showing that noise has been detected in a third processing status;

FIG. 9 is a diagram showing image re-forming processing of recovery operation for the third processing status;

FIG. 10 is a flowchart showing the flow of the recovery operation;

FIG. 11 is a diagram showing a noise detector that detects noise by using an antenna pattern;

FIG. 12 is a diagram showing a noise detector that detects noise by using a noise detection wire;

FIG. 13 is a diagram showing the entire configuration of an image forming apparatus according to a second embodiment;

FIG. 14 is a diagram showing that an abnormal image detector has detected an abnormal image;

FIG. 15 is a diagram showing image re-forming processing and discard processing of recovery operation caused by the abnormal image detection;

FIG. 16 is a diagram showing withdrawal processing of the recovery operation caused by the abnormal image detection;

FIG. 17 is a diagram showing discharge processing of the recovery operation caused by the abnormal image detection; and

FIG. 18 is a flowchart showing the flow of the recovery operation in the second embodiment.

### DETAILED DESCRIPTION OF EMBODIMENTS

Hereinafter, a technical idea of one or more embodiments of the present invention will be described with reference to the drawings. However, the scope of the invention is not limited to the disclosed embodiments. In the following description, the same components are denoted by the same reference numerals. Their names and functions are the same. Therefore, the detailed description thereof will not be repeated.

### First Embodiment

### Entire Configuration of Image Forming Apparatus

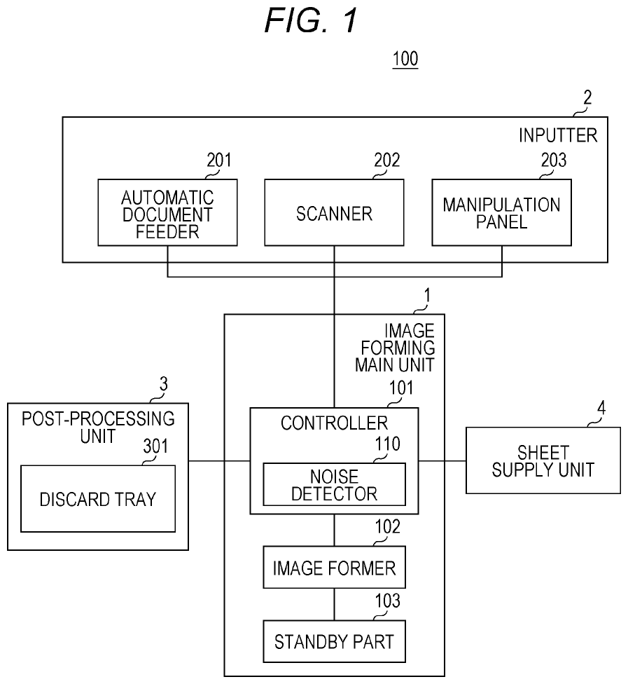

FIG. 1 is a diagram showing the entire configuration of an image forming apparatus 100. The image forming apparatus 100 is a copying machine, a printer, a facsimile, or a multifunction peripheral having these functions. An image forming method of the image forming apparatus 100 may be any one of an inkjet method or an electrophotographic method. The image forming apparatus 100 includes an image forming main unit 1, an inputter 2, a post-processing unit 3 and a sheet supply unit 4.

The image forming main unit 1 is a device that mainly performs print processing. The image forming main unit 1 includes a controller 101, an image former 102 and a standby part 103, and the controller 101 includes a noise detector 110. The controller 101 controls the entire image forming apparatus 100 collectively. The controller 101 is connected to the image former 102, the inputter 2, the post-processing unit 3, the sheet supply unit 4 and other predetermined devices (not shown) via cables, and transmits and receives control signals.

The controller 101 controls the entire image forming apparatus 100 collectively as well as processes image data in particular. The image data processing is processing performed on image data inputted by the inputter 2 so that the image former 102 can form an image on a sheet. Specifically, the image data processing includes processing of expanding image data read by a scanner 202 or an automatic document feeder 201 of the inputter 2 into bitmap data so that the image former 102 can form an image, processing of transferring the processed data to the image former 102, and the like. Also included is processing image data accepted from an external device (e.g., a personal computer) (not shown) connected to the image forming apparatus 100 via a communication network. The controller 101 also expands the image data accepted from the external device into bitmap data in the same manner as the image data read by the scanner 202 or the like and transfers the image data to the image former 102.

The noise detector 110 detects noise (electrostatic noise) generated due to occurrence of electrostatic discharge in any of the devices included in the image forming apparatus 100. When the electrostatic discharge occurs, electrostatic noise that becomes an abnormal voltage intrudes from the cable and flows into the controller 101 for several nanoseconds to several tens of nanoseconds, causing a misoperation in the image data processing. The noise detector 110 may detect the electrostatic noise flowing from the cable or may detect the electrostatic noise by an antenna provided in the board of the controller 101. Moreover, in another embodiment, the noise detector 110 may detect noise other than the electrostatic noise (e.g., signal noise, power supply noise, or a combination thereof).

The standby part 103 causes a sheet on which an image has been formed to temporarily stand by. For example, the standby part 103 causes one of sheets consecutively printed to temporarily stand by so that the sheet can be discharged later than a sheet to be supplied later. Accordingly, the order of discharge can be adjusted.

When the image forming method of the image forming apparatus 100 is an electrophotographic method, the image former 102 is a print head for exposure to a photoreceptor. The image former 102 accepts the bitmap data expanded by the controller 101 and performs exposure based on the bitmap data. That is, the image former 102 outputs a laser beam to the photoreceptor drum, performs exposure on the surface of the uniformly charged photoreceptor drum based on the bitmap data, and forms an electrostatic latent image. When the image forming apparatus 100 employs an inkjet method, the image former 102 is an inkjet head that ejects ink droplets onto a sheet.

The inputter 2 accepts an input from a user. The inputter 2 includes the automatic document feeder 201, the scanner 202 and a manipulation panel 203. The automatic document feeder 201 and the scanner 202 are devices that read an image printed on a sheet.

The scanner 202 is a platen-type device that reads sheets one by one by using platen glass. The scanner 202 transmits and receives image signals and control signals, which are of an image read by a charge coupled device (CCD) sensor included in the scanner 202, to and from the controller 101 via the cable.

The automatic document feeder 201 is a sheet-through type device that can automatically read a document composed of a plurality of pages, and is called an auto document feeder (ADF). The automatic document feeder 201 transmits and receives image signals and control signals, which are of an image read by a contact image sensor (CIS) included in the automatic document feeder 201, to and from the controller 101 via the cable. Both the scanner 202 and the automatic document feeder 201 read sheets with various sizes.

The manipulation panel 203 is a liquid crystal display (LCD) with a touch panel, accepts various manipulations from the user, and displays various setting screens and instructions when a malfunction or error occurs. The manipulation panel 203 transmits and receives control signals via the cable connected to the controller 101.

The sheet supply unit 4 supplies a sheet (e.g., paper, a film, a sticker or the like) to the image forming main unit 1. The sheet supply unit 4 transmits and receives control signals via the cable connected to the controller 101.

The post-processing unit 3 performs post-processing such as staple processing, saddle stitch processing and punching processing on the sheet on which the image has been formed. The post-processing unit 3 transmits and receives control signals via the cable connected to the controller 101. A discard tray 301 provided in the post-processing unit 3 is a tray for discarding a sheet on which an abnormal image has been formed and which occurs when noise has been detected.

### About Processing Status Upon Noise Detection

The processing status upon noise detection will be described. The controller 101 determines what recovery operation is to be performed depending on the timing when noise is detected. Since noise can be detected at any timing in the course of the processing, the status of the image forming processing differs from time to time. Therefore, recovery operation needed differs depending on the processing status when noise has been detected.

In the present embodiment, recovery operation for three processing statuses will be described. A first processing status is a processing status in which image forming processing is being performed to form an image on a sheet based on the image data being processed when noise has been detected. A second processing status is a processing status in which an image has been formed on a sheet based on the image data being processed when noise has been detected, and processing is being performed on the subsequent sheet based on the image data on the next page. A third processing status is a processing status in which image forming processing has not yet been performed to form an image on a sheet based on the image data being processed when noise has been detected.

When noise has been detected, the controller 101 determines which processing status is currently in progress, and determines which recovery operation is to be performed.

### Recovery Operation in First Processing Status

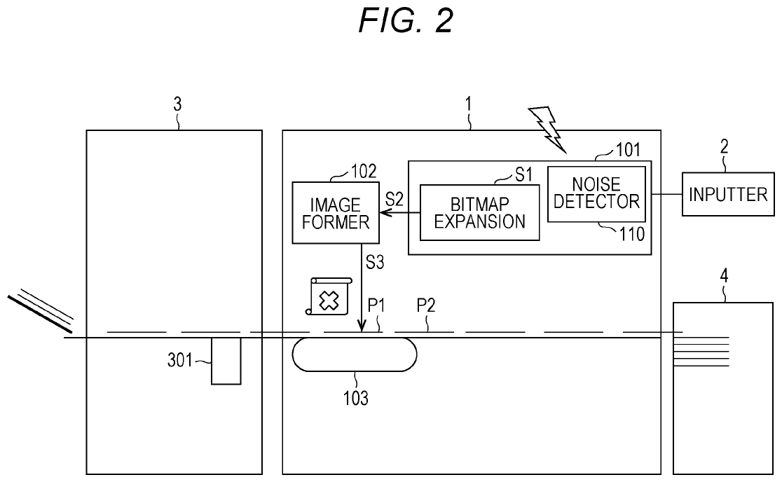

Hereinafter, the recovery operation when noise has been detected in the first processing status will be described. FIG. 2 is a diagram showing that noise has been detected in the first processing status.

In FIG. 2, the sheet supply unit 4, the image forming main unit 1 and the post-processing unit 3 are arranged in a line. A sheet supplied from the sheet supply unit 4 passes through the image forming main unit 1, then passes through the post-processing unit 3, and is discharged. The image forming main unit 1 performs image forming processing on the supplied sheet.

Moreover, the post-processing unit 3 performs various post-processings (staple processing, punching processing and the like) on the sheet on which the image forming processing has been performed. In the present embodiment, the post-processing unit 3 sorts out a sheet on which an abnormal image is printed in particular. The discard tray 301 is a tray for discarding a sheet on which the abnormal image is printed. The inputter 2 is connected to the controller 101 and inputs data accepted from the user.

The image forming main unit 1 includes, on a sheet conveyance path, the standby part 103 for causing a sheet to temporarily stand by. The image forming main unit 1 also includes the controller 101 including the noise detector 110. The controller 101 expands the accepted image data into bitmap data (Step S1). The expanded bitmap data is transferred from the controller 101 to the image former 102 (Step S2). The image former 102 performs image forming processing on a sheet to form an image of the transferred bitmap data (Step S3). In FIG. 2, the image former 102 is performing the image forming processing on a sheet P1.

When electrostatic discharge occurs in the controller 101 as indicated by a lightning pattern at the upper left from the noise detector 110, a misoperation occurs in the image data processing being performed by the controller 101, possibly leading to inclusion of abnormality in the processed image data. Thus, the controller 101 discards the sheet P1, on which the image based on the image data has been formed by the image former 102, to the discard tray 301 and controls to perform image re-forming processing on a sheet P2 subsequent to the sheet P1.

That is, the image former 102 has already formed an abnormal image on the sheet P1 (Step S3) and cannot form the image again on the sheet P1. Therefore, the controller 101 does not perform the image forming processing of the image of the next page on the sheet P2 subsequently supplied and performs again the processing of the same image as the image formed on the sheet P1.

When noise has been detected in the first processing status, the image re-forming processing is performed on the new sheet P2 subsequently supplied. Since the image re-forming processing is performed on the sheet P2 supplied subsequent to the sheet P1, the image forming apparatus 100 can shorten the time taken for performing the recovery operation.

If the image former 102 does not stop the image forming processing on the sheet P1 halfway at the time of the noise detection and stops after the entire image formation is completed, the timing of starting the image re-forming processing on the sheet P2 is delayed. In the controller 101, the timing of starting the image forming processing on the sheet P2 is preferably as soon as possible after the noise has been detected. Continuing to form the image on the sheet P1 after the noise detection is a waste of toner or ink. Thus, after the noise detection, the image former 102 stops the image forming processing on the sheet P1 halfway and switches to the image re-forming processing on the sheet P2 as soon as possible.

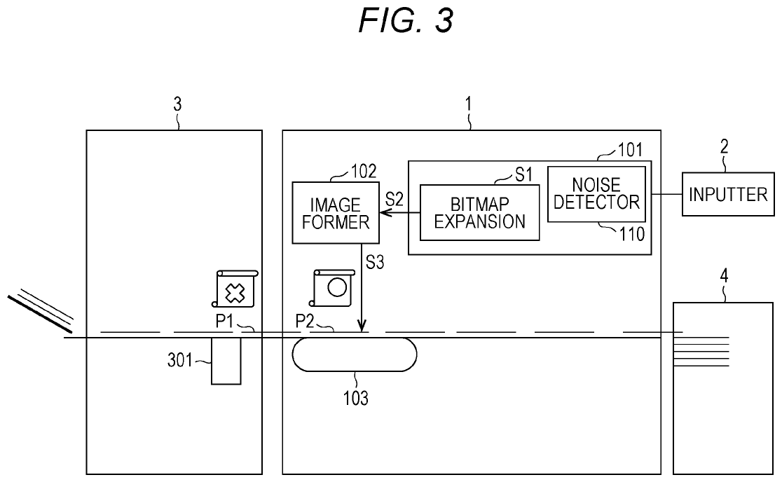

FIG. 3 is a diagram showing the image re-forming processing of the recovery operation for the first processing status. For the abnormal image formed on the sheet P1, the controller 101 performs the image re-forming processing on the sheet P2 subsequently supplied. That is, the controller 101 performs again the expansion processing into the bitmap data on the image formed on the sheet P1 (Step S1) as well as the transfer processing to the image former 102 (Step S2). Accordingly, the image former 102 accepts normal data, and a normal image is formed on the sheet P2.

The sheet pattern marked with a circle indicated above the sheet P2 indicates that the normal image has been formed on the sheet P2. Next, the discard processing of the sheet P1 on which the abnormal image has been formed will be described.

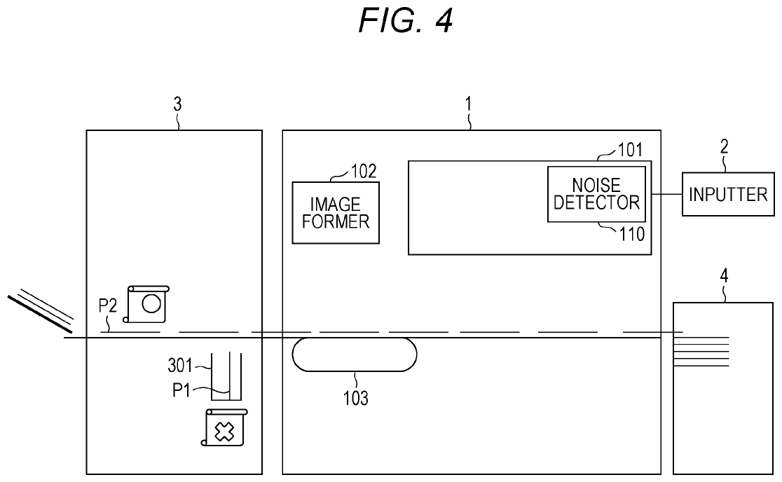

FIG. 4 is a diagram showing the discard processing of the recovery operation for the first processing status. FIG. 3 shows that the sheet P1 on which the abnormal image has been formed is discarded to the discard tray 301 of the post-processing unit 3. Since the sheet P1 is discarded to the discard tray 301 of the post-processing unit 3, the sheet P1 is not discharged to a discharge tray together with the sheet on which a normal image has been formed other than the sheet P1. Therefore, the image forming apparatus 100 according to the present embodiment does not impose a burden on the user to remove the sheet P1 from the plurality of discharged sheets.

As shown in FIGS. 2 to 4, the recovery operation for the first processing status is operation in which noise is detected while the image data processing is being performed on the sheet P1, and the image forming processing is performed again on the sheet P2 supplied subsequent to the sheet P1.

### Recovery Operation in Second Processing Status

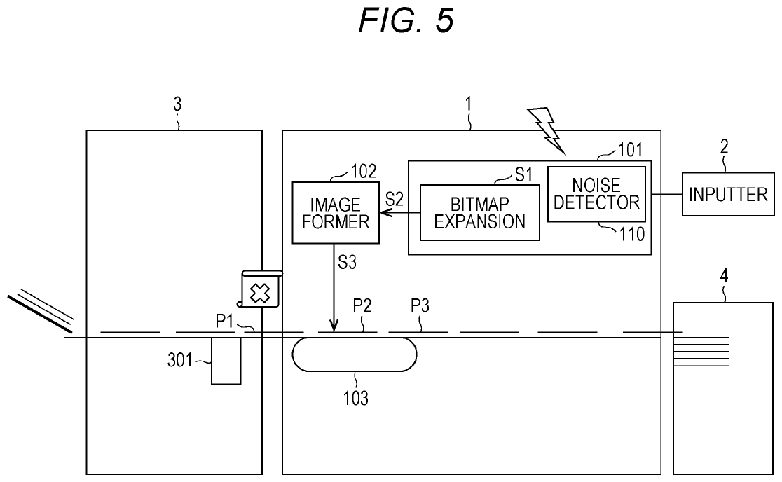

Hereinafter, the recovery operation when noise has been detected in the second processing status will be described. FIG. 5 is a diagram showing that noise has been detected in the second processing status. In FIG. 5, the image former 102 is performing image forming processing on a sheet P2.

In the second processing status, the noise detector 110 also detects noise generated at the same timing as in the first processing status. That is, noise generated at the timing of processing the image data formed on the sheet P1 is detected. Accordingly, an abnormal image is also formed on a sheet P1.

However, after accepting the noise detection from the noise detector 110, the controller 101 cannot stop the image forming processing on the sheet P2 for the image of the next page of the abnormal image in some cases. That is, this case includes a situation in which the data processing of the image to be formed on the sheet P2 has already been performed at the time when noise has been detected in a case where the controller 101 is continuously transferring the image data to the image former 102, or the like. This situation is assumed because the image forming apparatus 100 continuously performs the image forming processing at a speed as fast as possible in order to improve the productivity.

Referring to FIG. 5, an abnormal image has already been formed on the sheet P1, and normal image forming processing is being performed on the sheet P2. That is, the image of the next page of the abnormal image formed on the sheet P1 is expanded as bitmap data (Step S1) and transferred to the image former 102 (Step S2) by the controller 101. The image former 102 normally forms, on the sheet P2, the image of the next page of the abnormal image (Step S3).

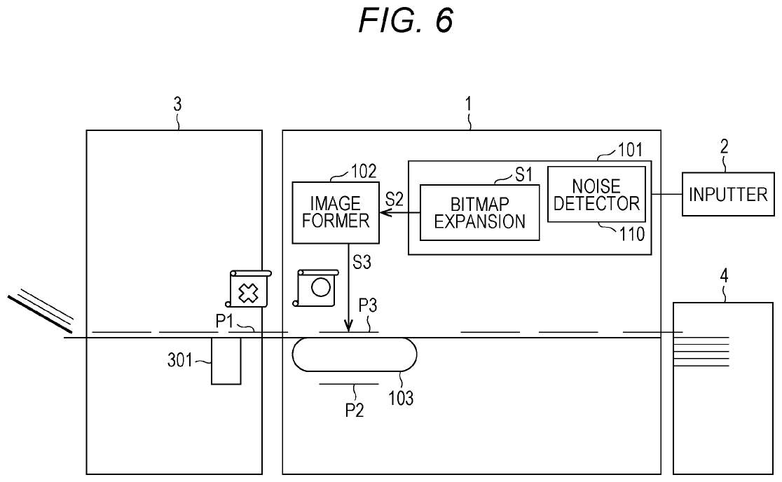

FIG. 6 is a diagram showing the image re-forming processing of the recovery operation for the second processing status. After the image of the next page of the abnormal image has been formed on the sheet P2, the controller 101 expands again into the bitmap data on the abnormal image formed on the sheet P1 (Step S1) and transfers the bitmap data to the image former 102 (Step S2). The image former 102 forms the image of the bitmap data on a sheet P3 (Step S3).

The standby part 103 causes the sheet P2, on which the image of the next page of the abnormal image has been formed, to temporarily stand by, unlike the first processing status. Unlike the first processing status, the image forming apparatus 100 adjusts the order of discharge because the order of discharging the sheet P2, on which the image of the next page of the abnormal image has been formed, and the sheet P3 is switched.

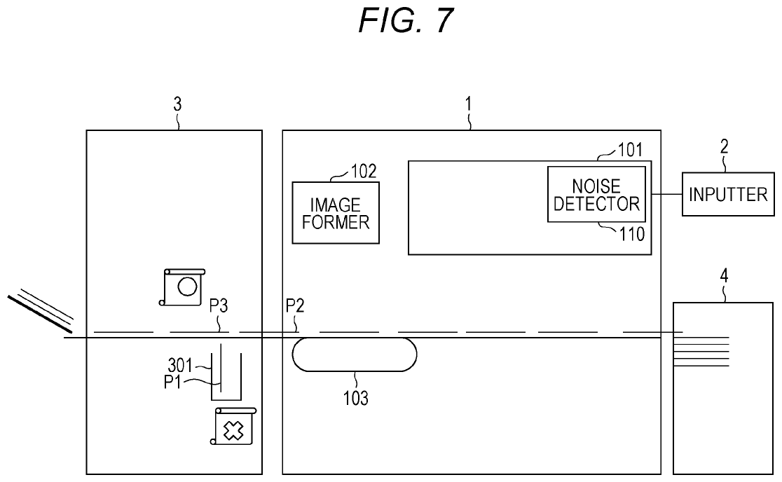

FIG. 7 is a diagram showing the discard processing of the recovery operation for the second processing status. The sheet P1, on which the abnormal image has been formed, is discarded to the discard tray 301 as in the first processing status. Therefore, a burden is not imposed on the user to remove the sheet P1 from the plurality of discharged sheets.

In the second processing status, the standby part 103 returns the standby sheet P2 to the conveyance path so as to be discharged after the sheet P3. Accordingly, the image forming apparatus 100 can discharge the sheets in the same order as in a case where no noise has occurred, while effectively utilizing the sheet P2 on which the image has been normally formed.

### Recovery Operation in Third Processing Status

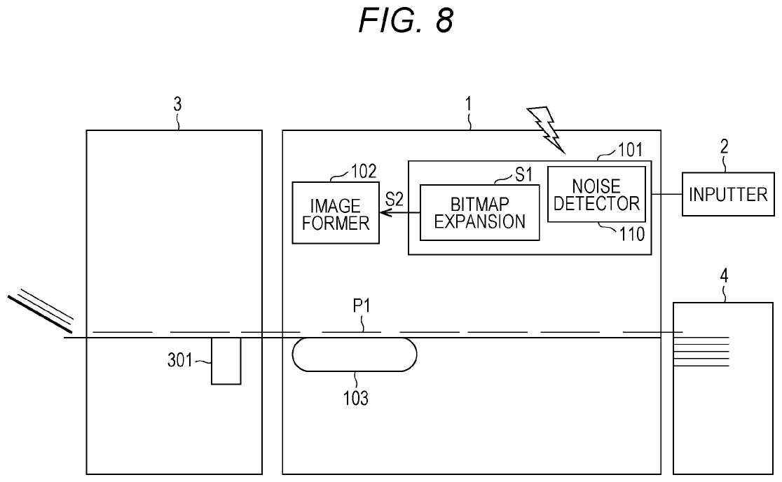

Hereinafter, the recovery operation when noise has been detected in the third processing status will be described. FIG. 8 is a diagram showing that noise has been detected in the third processing status. In FIG. 8, the controller 101 is processing image data.

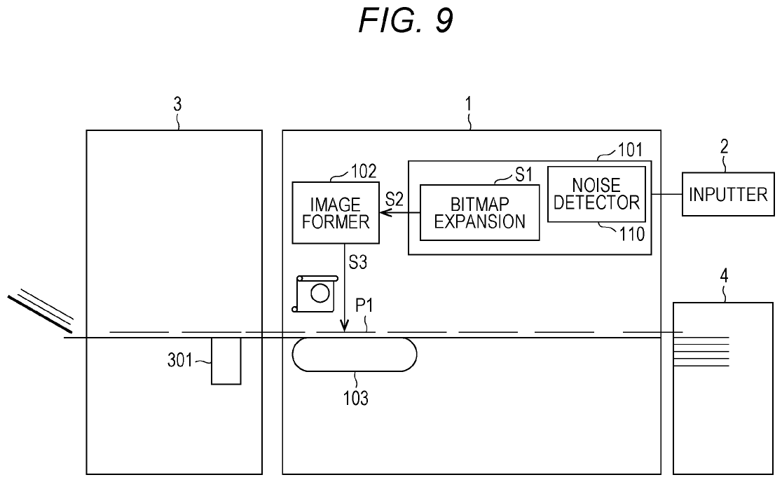

In the third processing status, the noise detector 110 also detects noise when image data processing is being performed. In the third processing status, unlike the first and second processing statuses, the controller 101 has not yet performed the image forming processing based on the image data being processed when the noise has been detected. Thus, the controller 101 performs again the bitmap data expansion processing and the transfer processing of the bitmap data, which are the image data processings. Accordingly, the image former 102 does not form an abnormal image on a sheet, and a sheet to be discarded can be eliminated, which is efficient. FIG. 9 is a diagram showing the image re-forming processing of the recovery operation for the third processing status. The controller 101 expands again the bitmap data for the same image (Step S1). After the expansion, the controller 101 transfers the bitmap data to the image former 102 (Step S2). The image former 102 forms, on a sheet P1, an image of the normally expanded and transferred bitmap data (Step S3). While performing the image re-forming processing, the sheet P1 stands by on the conveyance path.

That is, in the third processing status, the recovery operation is performed only for the image data processing. Therefore, there is no sheet to be discarded to the discard tray 301, and further, it is unnecessary to adjust the order of discharge by using the standby part 103.

If the formation of an abnormal image due to the noise can be detected only after the image former 102 has performed the image forming processing, a sheet, on which the abnormal image is formed, inevitably occurs, reducing the productivity. Therefore, as shown in the recovery operation for the third processing status, the noise detector 110 detects the noise, and the image re-forming processing is performed so that the image forming apparatus 100 can detect early the sheet that will have an abnormal image and improve the productivity.

### Flow of Recovery Operation

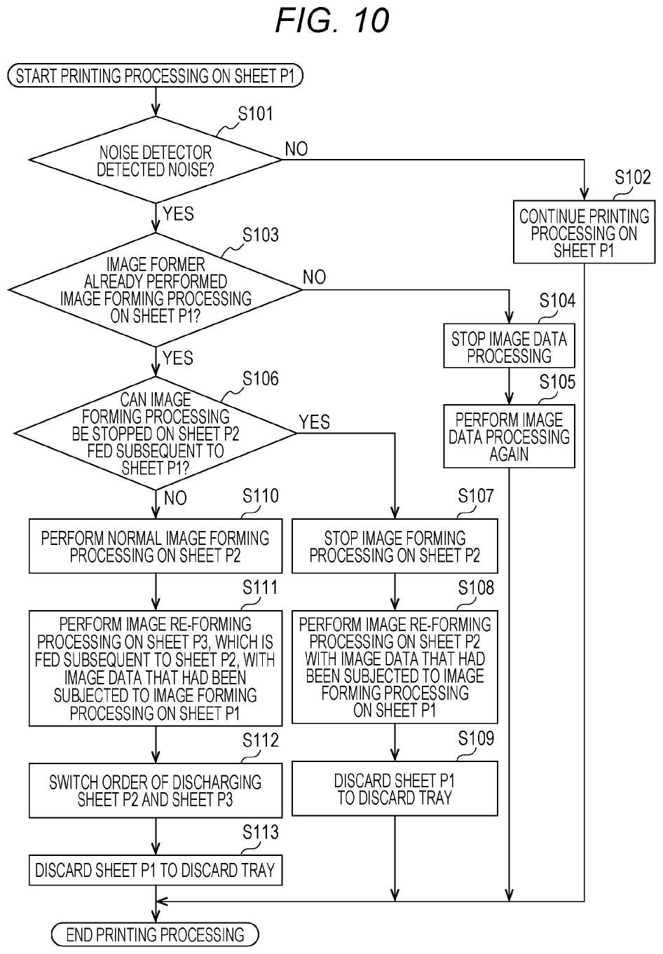

Hereinafter, the flow of the recovery operation during the printing processing will be described. FIG. 10 is a flowchart showing the flow of the recovery operation.

The controller 101 starts accepting the printing processing on the sheet P1. The controller 101 determines whether noise detector 110 has detected noise (Step S101). If noise has not been detected (NO in Step S101), the controller 101 continues the printing processing on the sheet P1 (Step S102) and ends the printing processing.

When noise has been detected (YES in Step S101), the controller 101 determines whether the image former 102 has already performed the image forming processing on the sheet P1 (Step S103). When the image forming processing has not already been performed on the sheet P1 (NO in Step S103), the controller 101 stops the image data processing (Step S104). After the stop, the image data processing is performed again (Step S105). That is, the same bitmap data is expanded again and transferred to the image former 102. Thereafter, the printing processing ends.

When the image forming processing has already been performed on the sheet P1 (YES in Step S103), the controller 101 determines whether the image forming processing on the sheet P2 supplied subsequent to the sheet P1 can be stopped (Step S106).

When the image forming processing on the sheet P2 supplied subsequent to the sheet P1 can be stopped (YES in Step S106), the controller 101 stops the image forming processing on the sheet P2 (step S107). Note that, when the image forming processing is still being performed on the sheet P1, the controller 101 also stops that processing. Stopping the processing prevents a waste of toner or ink. Thereafter, the controller 101 performs the image re-forming processing on the sheet P2 with the image data that had been subjected to the image forming processing on the sheet P1 (Step S108). After the image re-forming processing, the controller 101 discards the sheet P1 to the discard tray 301 (Step S109) and ends the printing processing.

In a case where the image forming processing on the sheet P2 supplied subsequent to the sheet P1 cannot be stopped (NO in Step S106), when the image forming processing is still being performed on the sheet P1, the controller 101 stops that processing and performs normal image forming processing on the sheet P2 (Step S110). After the image forming processing on the sheet P2, the controller 101 performs the image re-forming processing on the sheet P3, which is supplied subsequent to the sheet P2, with the image data that had been subjected to the image forming processing on the sheet P1 (Step S111). After the image re-forming processing, the controller 101 causes the standby part 103 to make the sheet P2 stand by, thereby switching the order of discharging the sheet P2 and the sheet P3 (Step S112). After switching the order of discharge, the controller 101 discards the sheet P1 to the discard tray 301 (Step S113) and ends the printing processing.

### Means for Noise Detection

There are various types of means for detecting noise. There are a detection means specialized for specific noise, a detection means depending on the environment, and the like. In the present embodiment, the noise detector 110 detects noise (electrostatic noise) caused by electrostatic discharge. The electrostatic noise is a transient noise generated when an electric charge of a human body or a device touches a surrounding object and is discharged. Hereinafter, two examples will be given as specific means for detecting the electrostatic noise.

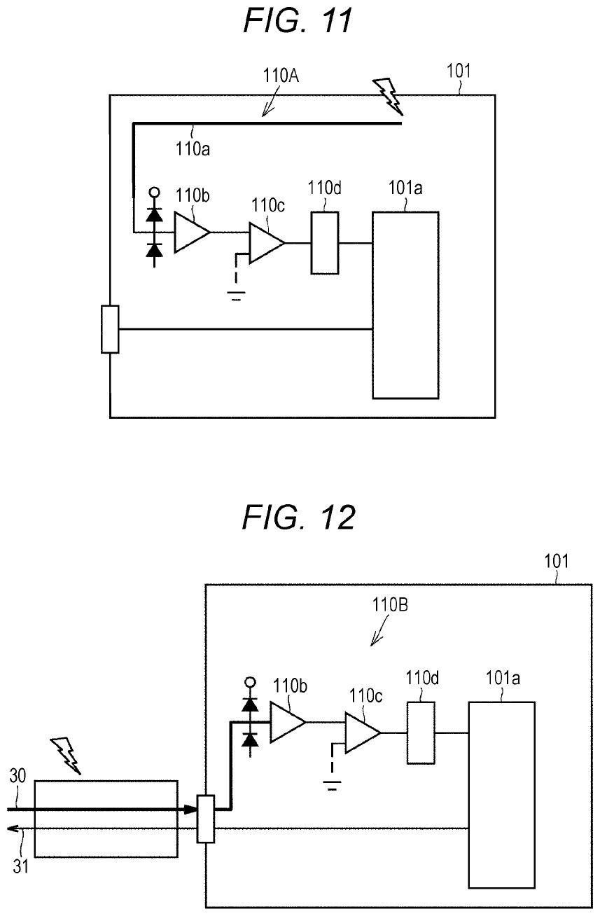

FIG. 11 is a diagram showing a noise detector 110A that detects noise by using an antenna pattern. The noise detector 110A shown in FIG. 11 has a noise detection antenna pattern 110a provided on the board of the controller 101. The noise detector 110A clamps, with a diode, the voltage of an electrostatic noise signal detected by the antenna pattern 110a, amplifies the voltage with an operational amplifier 110b, and detects whether or not the voltage is equal to or greater than a predetermined voltage with a comparator 110c. Moreover, when the noise detector 110A detects a noise signal with the predetermined voltage or more, a one-shot circuit 110d is used to convert the signal into a signal that can be processed by an integrated circuit 101a such as an application specific integrated circuit (ASIC). Note that the integrated circuit 101a is commonly utilized for other signal processing in the controller 101.

FIG. 12 is a diagram showing a noise detector 110B that detects noise by using a noise detection wire. In FIG. 12, the description of the same components as in FIG. 11 will not be repeated. The difference between FIGS. 12 and 11 is that a noise detection wire 30 is used instead of using an antenna pattern for the noise detection.

The noise detection wire 30 passes through the same cable as a control signal wire 31. That is, as shown in FIG. 1, the noise detection wire 30 passes between all the devices connected to the controller 101 by the cables. Accordingly, even when electrostatic discharge occurs in a device installed at a distance from the controller 101 and intrudes into the cable, the noise detection wire 30 can detect electrostatic noise.

As described above, the noise detection means has been described using two examples. However, the detection means is not limited thereto, and the noise is not limited only to the static electricity.

### Brief Summary

As described above, the image forming apparatus 100 according to the present embodiment includes: the manipulation panel 203 that inputs image data; the image former 102 that executes image forming processing to form an image on a sheet for each page with the image data inputted by the manipulation panel 203; the controller 101 that controls the image data processed at the image former 102; and the noise detector 110 that detects noise. When the noise detector 110 has detected noise while the image data is being processed, the controller 101 controls to perform, at the image former 102, the image re-forming processing for the page corresponding to the image data.

According to this, when the image data is being subjected to the image forming processing, the noise detection is performed by the noise detector so that it is possible to detect a sheet with a poor image early and improve the productivity.

Moreover, the image data processing performed by the controller 101 may include processing of expanding the image data into bitmap data. According to this, the image data read by the automatic document feeder 201 and the scanner 202 can be expanded as bitmap data.

Furthermore, the image data processing performed by the controller 101 may include processing of transferring the image data to the image former 102. According to this, the controller 101 transmits and receives the image data to and from the image former 102 such as a print head.

Further, in a case where the image forming processing is being performed to form, on a sheet, the image based on the image data being processed when noise has been detected, the controller 101 controls to perform, at the image former 102, the image re-forming processing on a sheet supplied subsequent to the sheet. According to this, when the image data is being subjected to the image forming processing, noise detection is performed by the noise detector 110, and the image re-forming processing is performed on the sheet to be subsequently supplied, thereby shortening the processing time of the recovery operation.

Moreover, in a case where the image forming processing is performed to form, on a sheet, the image based on the image data being processed when noise has been detected and the image data processing is being performed on the subsequent sheet for the next page at the image former 102, the controller 101 controls to perform, at the image former 102, the image re-forming processing on the sheet supplied after the subsequent sheet. According to this, when the image data is being subjected to the image forming processing, noise detection is performed by the noise detector 110, the image re-forming processing is performed on the sheet to be supplied after the sheet subsequently supplied to shorten the processing time of the recovery operation, and the order of discharge is adjusted.

Furthermore, in a case where the image forming processing has not yet been performed to form, on a sheet, the image based on the image data being processed when noise has been detected, the controller 101 controls to perform, at the image former 102, the image re-forming processing on the sheet. According to this, when the image data is being subjected to the image forming processing, noise detection is performed by the noise detector 110, and the image re-forming processing is performed on the standby sheet, thereby shortening the processing time of the recovery operation.

In addition, further included are the discharge tray that discharges a sheet, on which an image has been formed by the image former 102, to the user; and a discard tray 301 that is separate from the discharge tray and discards a sheet on which an abnormal image has been formed. The controller 101 conveys the sheet, on which the image has been formed based on the image data being processed when noise has been detected, to the discard tray 301. According to this, the sheet on which the abnormal image has been formed is discarded to the discard tray instead of being discharged to the discharge tray so that a burden is not imposed on the user to remove the sheet, on which the abnormal image has been formed, from the plurality of discharged sheets.

Moreover, the standby part 103 is further included to cause the sheet, on which the image has been formed by the image former 102, to temporarily stand by, and the controller 101 causes the standby part 103 to make the sheet, on which the image of the image data on the next page has been formed, stand by. According to this, even when noise has been detected and the image re-forming processing is performed, the order of discharge can be adjusted, and a burden is not imposed on the user to remove the sheet, on which the abnormal image has been formed, from the plurality of discharged sheets.

Furthermore, the image former 102 forms an image on a sheet by transferring a toner image, which is formed on an electrophotographic photoreceptor, onto the sheet. According to this, the image can be formed on the sheet by an electrophotographic method.

Further, the image former 102 forms an image on a sheet by an inkjet method. According to this, the image can be formed on the sheet by an inkjet method.

Moreover, the image former 102 forms a multicolor image on a sheet. According to this, not only monochrome, but also color image forming processing can be performed.

Furthermore, the noise detector 110 is provided with the noise detection wires 30 for detecting noise in the respective cables that connect the controller 101 and other devices, and has a detection circuit that individually detects noise for each of the noise detection wires 30 provided in each cable. According to this, it is possible to detect noise generated in each device connected to the controller 101.

Further, the controller 101 is provided with the antenna pattern 110a for detecting noise on the board in the controller 101 and has the processing circuit that processes the noise detected by the antenna pattern 110a. According to this, the noise detector 110 can detect electrostatic noise with the antenna pattern 110a.

Moreover, the image forming method according to the present embodiment is an image forming method of an image forming apparatus including: the manipulation panel 203 that inputs image data; the image former 102 that executes image forming processing to form an image on a sheet for each page with the image data inputted by the manipulation panel 203; the controller 101 that controls the image data processed at the image former 102; and the noise detector 110 that detects noise. Included are steps of: detecting noise by the noise detector 110 while the image data is being processed by the image former 102; and controlling, by the controller 101, to perform image re-forming processing at the image former 102 for the page corresponding to the image data when the noise detector 110 has detected noise.

According to this, when the image data is being subjected to the image forming processing, the noise detection is performed by the noise detector so that it is possible to detect a sheet with a poor image early and improve the productivity.

### Second Embodiment

In the image forming apparatus 100 according to the first embodiment, the noise detector is used to detect an abnormal image. Accordingly, it is possible to detect data affected by noise before the image former starts forming an abnormal image on a sheet and to prevent the generation itself of an abnormal image. Moreover, even after the image former has started forming an abnormal image on a sheet, it is possible to shorten the time required for the entire recovery operation by promptly starting the recovery operation.

However, the cause of the abnormal image generation is not limited to noise generation. In the electrophotographic method, there may be a case where toner adheres to a fixing unit due to a paper jam, causing an abnormal image formed on a sheet. In the inkjet method, there may be a case where an ink bleeding abnormal image is formed.

Thus, an image forming apparatus according to a second embodiment further includes an abnormal image detector in addition to a noise detector, and this abnormal image detector detects an abnormal image due to causes other than noise. Note that, in the image forming apparatus according to the second embodiment, the same constituents as those of the image forming apparatus 100 according to the first embodiment shown in FIGS. 1, 11 and 12 are denoted by the same reference numerals, and the detailed description thereof will not be repeated.

### Entire Configuration of Image Forming Apparatus

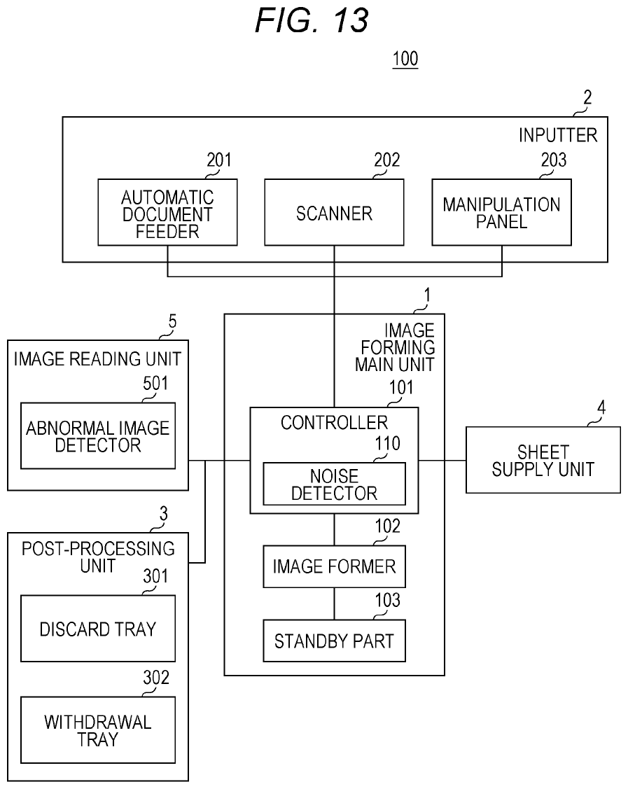

FIG. 13 is a diagram showing the entire configuration of an image forming apparatus 100 according to the second embodiment. The description of the same hardware components as the image forming apparatus 100 according to the first embodiment will not be repeated, and only different hardware component will be described.

The image forming apparatus 100 according to the second embodiment includes an image reading unit 5 called an image calibration control unit (ICCU) in addition to the hardware components included in the image forming apparatus 100 according to the first embodiment. The image reading unit 5 includes an abnormal image detector 501 that determines whether or not a read image is abnormal. Note that the image reading unit 5 is not limited to the ICCU and may be another device that reads an image.

The image reading unit 5 includes, for example, a linear image sensor (e.g., a CCD line sensor and the like), an optical system, a light source, and the like and reads an image transferred onto a sheet. The abnormal image detector 501 detects whether or not the obtained read image is an abnormal image and outputs the detection result to a controller 101. Note that the determination as to whether or not the read image is an abnormal image may be made by the controller 101.

Note that the image reading unit 5 can measure the color of the image on the sheet in the present embodiment, but is not particularly limited as long as at least the sheet region and the image region can be recognized. Moreover, the arrangement position of the image reading unit 5 is not particularly limited as long as the position is at the downstream of an image former 102 and the upstream of a withdrawal tray 302 described later and is at where both sides (may be one side at a time) of a sheet can be read.

A post-processing unit 3 includes the withdrawal tray 302 separate from a discard tray 301. The withdrawal tray 302 temporarily withdraws a plurality of sheets with abnormal images detected by the abnormal image detector 501. Accordingly, the order of discharging the sheets can be adjusted.

### Recovery Operation by Abnormal Image Detection

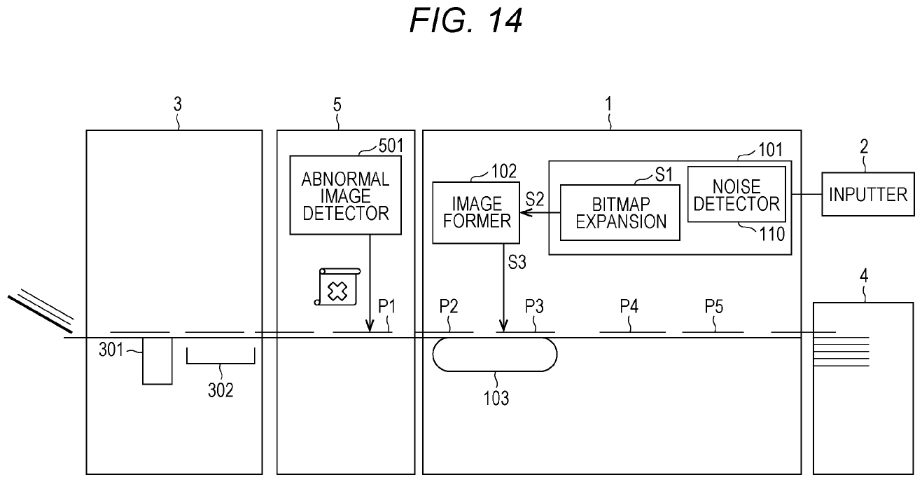

Hereinafter, the recovery operation using the abnormal image detector 501 will be described. FIG. 14 is a diagram showing that the abnormal image detector 501 has detected an abnormal image. The description of the same hardware components as the image forming apparatus 100 according to the first embodiment will not be repeated.

The image reading unit 5 is arranged at the downstream of an image forming main unit 1 and the upstream of the post-processing unit 3. Sheets consecutively supplied from a sheet supply unit 4 are subjected to image forming processing at the image forming main unit 1, and the image reading unit 5 detects whether or not the images formed on the sheets are abnormal. Thereafter, the sheets are subjected to post-processing including withdrawal processing at the post-processing unit 3 and discharged to a discharge tray.

In FIG. 14, the abnormal image detector 501 of the image reading unit 5 detects that the image formed on a sheet P1 is an abnormal image. That is, the abnormal image formed on the sheet P1 is generated because a noise detector 110 could not detect the abnormal image. The abnormal image detector 501 notifies the controller 101 of that the abnormal image has been detected. The sheet supply unit 4 supplies sheets in the order of a sheet P2, a sheet P3, a sheet P4 and a sheet P5 after the sheet P1.

In the second embodiment, when the abnormal image detector 501 has detected the abnormal image formed on the sheet P1, the image former 102 is performing normal image forming processing on the sheet P3. That is, an image corresponding to two pages after the abnormal image formed on the sheet P1 is being formed on the sheet P3. An image of the next page of the abnormal image has already been formed on the sheet P2. This is because the abnormal image is detected after a certain period time elapsed after the image forming processing since there is a certain distance between the image former 102 and the abnormal image detector 501.

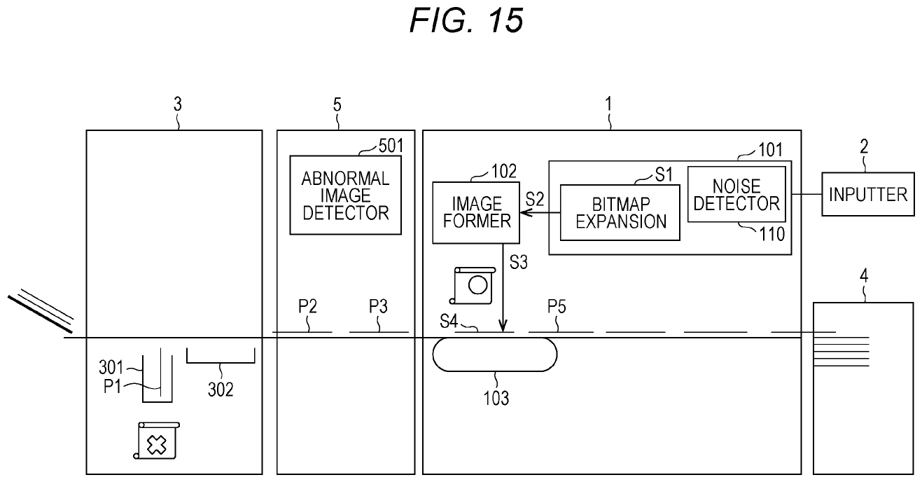

FIG. 15 is a diagram showing image re-forming processing and discard processing of the recovery operation caused by the abnormal image detection. The controller 101 starts the recovery operation in response to the notification of the detection of the abnormal image from the abnormal image detector 501. In accordance with a command from the controller 101, the image former 102 performs the image re-forming processing on the sheet P4 for the abnormal image formed on the sheet P1. In accordance with a command from the controller 101, the post-processing unit 3 discards the sheet P1, on which the abnormal image has been formed, to the discard tray 301.

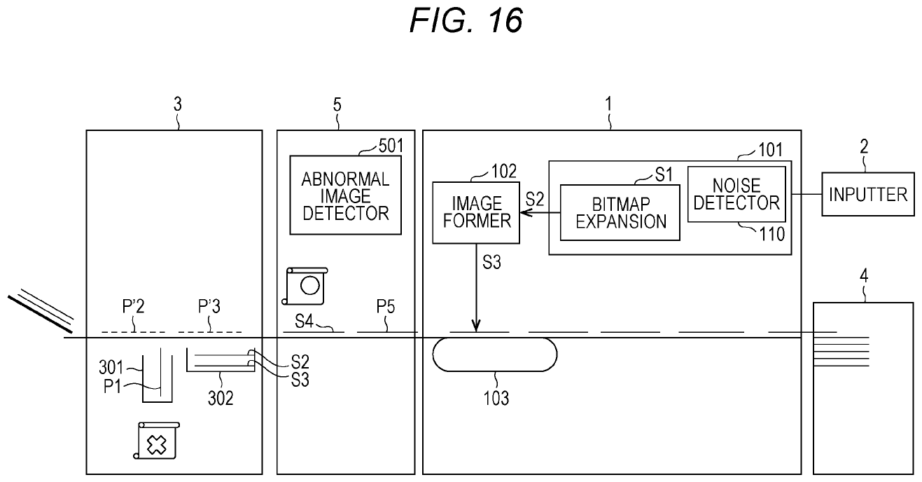

FIG. 16 is a diagram showing withdrawal processing of the recovery operation caused by the abnormal image detection. The post-processing unit 3 withdraws the sheet P2 and the sheet P3, on which normal images have been formed, to the withdrawal tray 302. This is to adjust the order of discharge. Since the sheet P4, on which the image re-forming processing has been performed, should be discharged prior to the sheet P2 and the sheet P3, the sheet P2 and the sheet P3 are temporarily withdrawn. A sheet P′2 and a sheet P′3 mean the processing of the discharged sheets if the sheets P2 and P3 were not withdrawn.

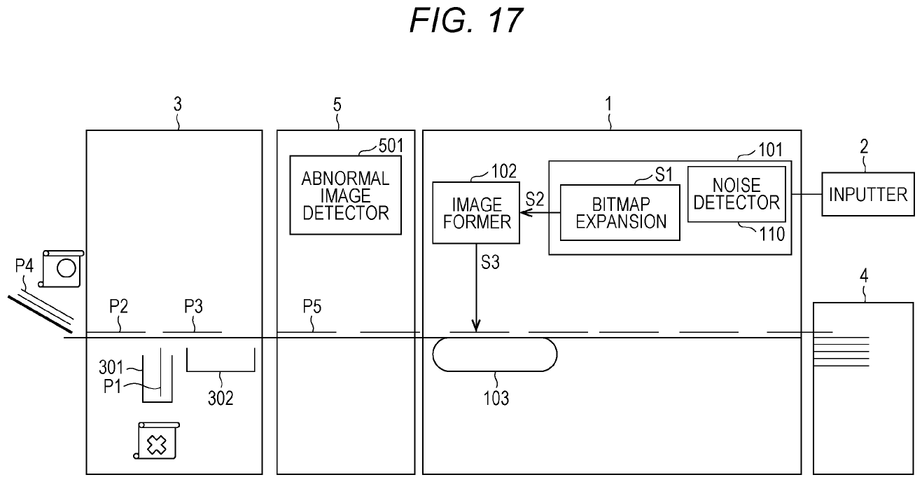

FIG. 17 is a diagram showing discharge processing of the recovery operation caused by the abnormal image detection. After the sheet P4 has been discharged, the post-processing unit 3 discharges the sheet P2 and the sheet P3 in this order. Accordingly, the order of discharge is adjusted. The sheet P5 is discharged after the sheet P3.

By using the abnormal image detector 501, it is possible to detect an abnormal image due to causes other than noise. Moreover, since the image forming apparatus 100 according to the second embodiment includes the noise detector 110, it is possible to detect noise and detect generation of an abnormal image before a sheet is conveyed to the abnormal image detector 501.

### Flow of Recovery Operation in Second Embodiment

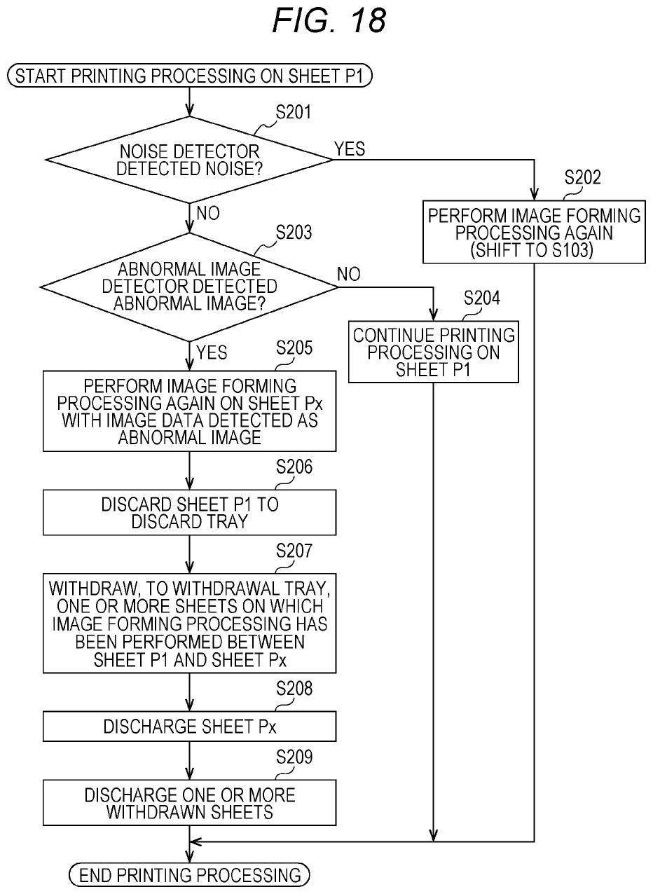

FIG. 18 is a flowchart showing the flow of the recovery operation in the second embodiment. The controller 101 starts accepting the printing processing on the sheet P1. The controller 101 determines whether or not the noise detector 110 has detected noise (Step S201). When the noise detector 110 has detected noise (YES in Step S201), the controller 101 performs image re-forming processing (Step S202). That is, the processing moves to Step S103 in FIG. 10 and ends.

When the noise detector 110 has not detected noise (NO in Step S201), the controller 101 determines whether or not the abnormal image detector 501 has detected an abnormal image (Step S203). When the abnormal image detector 501 has not detected an abnormal image (NO in Step S203), the controller 101 continues the printing processing on the sheet P1 (Step 5204) and ends the processing.

When the abnormal image detector 501 has detected an abnormal image (YES in Step S203), the controller 101 performs the image re-forming processing on a sheet Px, which is supplied later than the sheet P1, with the image data detected as the abnormal image (Step S205). After the image re-forming processing, the controller 101 commands the post-processing unit 3 to discard the sheet P1 to the discard tray 301 (Step S206).

After the discard, the controller 101 commands the post-processing unit 3 to withdraw, to the withdrawal tray 302, one or more sheets on which the image forming processing has been performed between the sheet P1 and the sheet Px (Step S207). After the withdrawal, the controller 101 commands the post-processing unit 3 to discharge the sheet Px prior to the withdrawn sheets (Step S208). After the discharge, the controller 101 commands the post-processing unit 3 to discharge one or more withdrawn sheets (Step S209).

### Brief Summary

The image forming apparatus 100 according to the present embodiment further includes the abnormal image detector 501 that reads an image on a sheet, on which the image former 102 has formed an image, and detects an abnormality of the image. When the abnormal image detector 501 has detected an abnormality of the image, the controller 101 controls to perform, at the image former 102, the image re-forming processing for the page of the image with the abnormality detected. According to this, an abnormal image that cannot be detected by the noise detector 110 can be detected by the abnormal image detector 501.

Although embodiments of the present invention have been described and illustrated in detail, the disclosed embodiments are made for purposes of illustration and example only and not limitation. The scope of the present invention should be interpreted not by terms of the above description but by terms of the appended claims, and is intended to include all modifications within the meaning and scope equivalent to the claims.

What is claimed is:

1. An image forming apparatus that forms an image, the image forming apparatus comprising:
an inputter that inputs image data;
an image former that executes image forming processing to form an image on a sheet for each page with the image data inputted by the inputter;
a controller that controls the image data processed at the image former; and
a noise detector that detects noise,
wherein the controller controls to perform, at the image former, image re-forming processing for a page corresponding to image data when the noise detector has detected noise when the image data is being processed.

2. The image forming apparatus according to claim 1, wherein image data processing performed by the controller includes processing of expanding the image data into bitmap data.

3. The image forming apparatus according to claim 1, wherein image data processing performed by the controller includes processing of transferring the image data to the image former.

4. The image forming apparatus according to claim 1, wherein the controller controls to perform, at the image former, the image re-forming processing on a sheet supplied subsequent to the sheet in a case where the image forming processing is being performed to form, on the sheet, an image based on the image data being processed when the noise has been detected.

5. The image forming apparatus according to claim 1, wherein the controller controls to perform, at the image former, the image re-forming processing on a sheet supplied after a subsequent sheet in a case where the image forming processing has been performed to form, on a sheet, an image based on the image data being processed when the noise has been detected, and the image data processing is being performed on the subsequent sheet for a next page.

6. The image forming apparatus according to claim 1, wherein the controller controls to perform, at the image former, the image re-forming processing on a sheet in a case where the image forming processing has not yet been performed to form, on the sheet, an image based on the image data being processed when the noise has been detected.

7. The image forming apparatus according to claim 4, further comprising:
a discharge tray that discharges a sheet, on which an image has been formed by the image former, to a user; and
a discard tray that is separate from the discharge tray and discards a sheet on which an abnormal image has been formed,
wherein the controller conveys the sheet, on which the image has been formed based on the image data being processed when the noise has been detected, to the discard tray.

8. The image forming apparatus according to claim 5, further comprising a standby part that causes the sheet, on which the image has been formed by the image former, to temporarily stand by,
wherein the controller causes the standby part to make the sheet, on which an image of the image data on the next page has been formed, stand by.

9. The image forming apparatus according to claim 1, further comprising an abnormal image detector that reads an image on a sheet, on which the image former has formed the image, and detects an abnormality of the image,
wherein the controller controls to perform, at the image former, the image re-forming processing for a page of an image with an abnormality detected when the abnormal image detector has detected the abnormality of the image.

10. The image forming apparatus according to claim 1, wherein the image former forms the image on the sheet by transferring a toner image, which is formed on an electrophotographic photoreceptor, onto the sheet.

11. The image forming apparatus according to claim 1, wherein the image former forms the image on the sheet by an inkjet method.

12. The image forming apparatus according to claim 1, wherein the image former forms a multicolor image on the sheet.

13. The image forming apparatus according to claim 1,
wherein the noise detector is provided with a noise detection wire for detecting noise in each cable that connects the controller and another device, and
has a detection circuit that individually detects noise for each noise detection wire provided in each cable.

14. The image forming apparatus according to claim 1,
wherein the controller is provided with an antenna for detecting noise on a board in the controller, and
has a processing circuit that processes the noise detected by the antenna.

15. An image forming method of an image forming apparatus comprising: an inputter that inputs image data; an image former that executes image forming processing to form an image on a sheet for each page with the image data inputted by the inputter; a controller that controls the image data processed at the image former; and a noise detector that detects noise, the image forming method comprising:
detecting noise by the noise detector when the image data is being processed; and
controlling, by the controller, to perform, at the image former, image re-forming processing for a page corresponding to the image data when the noise detector has detected noise.
